(19) United States
(12) Patent Application Publication
(10) Pub. No.: US 2023/0222326 A1
(43) Pub. Date: Jul. 13, 2023

(54) METHOD AND SYSTEM FOR TRAINING A NEURAL NETWORK MODEL USING GRADUAL KNOWLEDGE DISTILLATION

(71) Applicants: Aref JAFARI, Waterloo (CA); Mehdi REZAGHOLIZADEH, Montreal (CA); Ali GHODSI, Waterloo (CA); Pranav SHARMA, Kanata (CA)

(72) Inventors: Aref JAFARI, Waterloo (CA); Mehdi REZAGHOLIZADEH, Montreal (CA); Ali GHODSI, Waterloo (CA); Pranav SHARMA, Kanata (CA)

(21) Appl. No.: 18/119,221

(22) Filed: Mar. 8, 2023

Related U.S. Application Data
(63) Continuation of application No. PCT/CA2021/051248, filed on Sep. 9, 2021.
(60) Provisional application No. 63/076,368, filed on Sep. 9, 2020.

(51) Int. Cl. G06N 3/045; G06N 3/096

(52) U.S. Cl. CPC G06N 3/045; G06N 3/096

(57) ABSTRACT

Method and system of training a student neural network (SNN) model. A first training phase is performed over a plurality of epochs during which a smoothing factor to teacher neural network (TNN) model outputs to generate smoothed TNN model outputs, a first loss is computed based on the SNN model outputs and the smoothed TNN model outputs, and an updated set of the SNN model parameters is computed with an objective of reducing the first loss in a following epoch of the first training phase. The soothing factor is adjusted over the plurality of epochs of the first training phase to reduce a smoothing effect on the generated smoothed TNN model outputs. A second training phase is performed based on the SNN model outputs and a set of predefined expected outputs for the plurality of input data samples.

### RELATED APPLICATION DATA

The present application is a continuation of International Pat. Application No. PCT/CA2021/051248, filed Sep. 9, 2021, the content of which is incorporated herein by reference, which claims priority to, and the benefit of, provisional U.S. Pat. application no. 63/076,368, filed Sep. 9, 2020, the content of which is incorporated herein by reference.

### FIELD

The present application relates to methods and systems for training machine learning models, and, in particular, methods and systems for training a neural network model using knowledge distillation.

### BACKGROUND

Deep learning based algorithms are machine learning methods used for many machine learning applications in natural language processing (NLP) and computer vision (CV) fields. Deep learning consists of composing layers of non-linear parametric functions or “neurons” together and training the parameters or “weights”, typically using gradient-based optimization algorithms, to minimize a loss function. One key reason of the success of these methods is the ability to improve performance with an increase in parameters and data. In NLP this has led to deep learning architectures with billions of parameters (Brown et. al 2020). Research has shown that large architectures or “models” are easier to optimize as well. Model compression is thus imperative for any practical application such as deploying a trained machine learning model on a phone for a personal assistant.

Knowledge distillation (KD) is a neural network compression technique whereby the generalizations of a complex neural network model are transferred to a less complex neural network model that is able to make comparable inferences (i.e. predictions) as the complex model at less computing resource cost and time. Here, complex neural network model refers to a neural network model with a relatively high number of computing resources such as GPU/CPU power and computer memory space and/or those neural network models including a relatively high number of hidden layers. The complex neural network model, for the purposes of KD, is sometimes referred to as a teacher neural network model (T) or a teacher for short. A typical drawback of the teacher is that it may require significant computing resources that may not be available in consumer electronic devices, such as mobile communication devices or edge computing devices. Furthermore, the teacher neural network model typically requires a significant amount of time to infer (i.e. predict) a particular output for an input due to the complexity of the teacher neural network model itself, and hence the teacher neural network model may not be suitable for deployment to a consumer computing device for use therein. Thus, KD techniques are applied to extract, or distill the learned parameters, or knowledge, of a teacher neural network model and impart such knowledge to a less sophisticated neural network model with faster inference time and reduced computing resource and memory space cost that may with less effort on consumer computing devices, such as edge devices. The less complex neural network model is often referred to as the student neural network model (S) or a student for short. The KD techniques involve training the student using not only the labeled training data samples of the training dataset but also using the outputs generated by the teacher neural network model, known as logits.

In an example of a KD solution, given a training dataset of sample pairs

$${\left\{\left({x}_{i} , {y}_{i}\right)\right\}}_{i = 1}^{N}$$

where xᵢ is the input vector and the yᵢ is the target one hot vector of classes ( e.g., classification labels), a loss function can include two components:
a) A first loss function ℒ_{CE} component is a cross entropy loss function between the output (logits) of the student neural network S(.) and the target one hot vector of classes. Here wₛ is the parameter vector of the student neural network.
$${L}_{C E} \left({w}_{s}\right) = - \frac{1}{N} {\sum }_{i = 1}^{N} {y}_{i} ⋅ l o g {S}_{{w}_{s}} \left({x}_{i}\right)$$
b) A second loss function ℒ_{KD} parameter is a Kullback-Leibler divergence (KL divergence) loss function between the outputs of the student neural network S(.) and the teacher neural network T(.).
$${L}_{K D} \left({w}_{s}\right) = \frac{1}{N} {\sum }_{i = 1}^{N} T \left({x}_{i}\right) ⋅ l o g \frac{T \left({x}_{i}\right)}{{S}_{{w}_{s}} \left({x}_{i}\right)}$$

In the above example, the total KD loss defines as:

$$L \left({w}_{s}\right) = \left(1 - α\right) {L}_{C E} \left({w}_{s}\right) + α {L}_{K D} \left({w}_{s}\right)$$

where a is a hyper parameter for controlling the trade-off between the two losses.

Stated another way, KD assumes that extracted knowledge about the training dataset exists in the logits of the trained teacher network, and that this knowledge can be transferred from the teacher to the student model by minimizing a loss function between the logits of student and teacher networks.

The total KD loss function can also be stated as follows:

$$\text{L} = \left(1 - \text{α}\right) * \text{H} \left(\text{y,} \text{σ} \left(\text{zs;T} = 1\right)\right) + \left(\text{α}\right) * \text{H} \left(\text{σ} \left(\text{zt;} ⊤ {=}_{⊤}\right) , \text{σ} \left(\text{zs,} ⊤ {=}_{⊤}\right)\right)$$

where H is the cross-entropy function (other loss functions may also be used), σ is the softmax function with parameter τ (learnable parameters of the neural network), and zt and zs are the logits (i.e., the output of the neural network before the last softmax layer) of the teacher neural network and student neural network respectively.

The KD algorithm is a widely used because it is agnostic to the architectures of the neural networks of the teacher and the student and requires only access to the outputs generated by the neural network of the teacher. Still for many applications there is a significant gap between the performance of the teacher and the performance of the student and various algorithms have been proposed to reduce this gap.

Problems can arise where there is a large computational capacity gap between the student and the teacher networks. The larger the gap between the teacher and the student neural networks, the more difficult the training of the student using KD can be. In particular, the larger the gap the “sharper” the KD loss function based on the structure of teacher and the student neural networks. Training based on sharp loss functions is more difficult than training based on flat loss functions. Although larger neural networks can handle the sharp loss functions, smaller networks with limited computational capacity like student neural networks can experience difficulties, such as descending into false minimums during gradient decent, when faced with sharp loss functions.

Accordingly, there is need for a system and method of KD training that can enable smaller student neural networks to be trained without experiencing sharp loss functions. Improvements in methods of training a neural network model using knowledge distillation to reduce a difference between the accuracy of the teacher model and the accuracy of the student model are desirable.

### SUMMARY

According to a first example aspect of the disclosure is a method of training a student neural network (SNN) model that is configured by a set of SNN model parameters to generate outputs in respect of input data samples. The method includes: obtaining respective teacher neural network (TNN) model outputs for a plurality of input data samples; performing a first training phase of the SNN model, the first training phase comprising training the SNN model over a plurality of epochs. Each epoch includes: computing SNN model outputs for the plurality of input data samples; applying a smoothing factor to the teacher neural network (TNN) model outputs to generate smoothed TNN model outputs; computing a first loss based on the SNN model outputs and the smoothed TNN model outputs; and computing an updated set of the SNN model parameters with an objective of reducing the first loss in a following epoch of the first training phase. The soothing factor is adjusted over the plurality of epochs of the first training phase to reduce a smoothing effect on the generated smoothed TNN model outputs. The method also comprises performing a second training phase of the SNN model, the second training phase comprising initializing the SNN model with a set of SNN model parameters selected from the updated sets of SNN model parameters computed during the first training phase, the second training phase of the SNN model being performed over a plurality of epochs, each epoch comprising: computing SNN model outputs for the plurality of input data samples from the SNN model; and computing a second loss based on the SNN model outputs and a set of predefined expected outputs for the plurality of input data samples; computing an updated set of the SNN model parameters with an objective of reducing the second loss for in a following epoch of the second training phase. A final set of SNN model parameters is selected from the updated sets of SNN model parameters computed during the second training phase.

The method can gradually increases the sharpness of a loss function used for KD training, which in at least some applications may enable more efficient and accurate training of a student neural network model, particularly when there is a substantial difference between the computational resources available for the teacher neural network model relative to those available for the student neural network model.

According to example aspects of the first example aspect, each epoch of the first training phase the smoothing factor is computed as smoothing

$$\text{factor} = \frac{t}{{t}_{m a x}} ,$$

where tₘₐₓ is a constant and a value of t is incremented in each subsequent epoch of the first training phase.

According to one or more of the preceding aspects, the first loss corresponds to a divergence between the SNN model outputs and the smoothed TNN model outputs.

According to one or more of the preceding aspects, the first loss corresponds to a Kullback-Leibler divergence between the SNN model outputs and the smoothed TNN model outputs.

According to one or more of the preceding aspects, the second loss corresponds to a divergence between the SNN model outputs and the set of predefined expected outputs.

According to one or more of the preceding aspects, the second loss is computed based on a cross entropy loss function.

According to one or more of the preceding aspects, the method further includes, for each epoch of the first training phase, determining if the computed updated set of the SNN model parameters improves a performance of the SNN model relative to updated sets of SNN model parameters previously computed during the first training phase in respect of a development dataset that includes a set of development data samples and respective expected outputs, and when the computed updated set of the SNN model parameters does improve the performance, update the SNN model parameters to the computed updated set of the SNN model parameters prior to a next epoch.

According to one or more of the preceding aspects, the set of SNN model parameters used to initialize the SNN model for the second training phase is the updated set of SNN model parameters computed during the first training phase that best improves the performance of the SNN model during the first training phase.

According to one or more of the preceding aspects, the method includes for each epoch of the second training phase, determining if the computed updated set of the SNN model parameters improves a performance of the SNN model relative to updated sets of SNN model parameters previously computed during the second training phase in respect of the development dataset, and when the computed updated set of the SNN model parameters does improve the performance, update the SNN model parameters to the computed updated set of the SNN model parameters prior to a next epoch.

According to one or more of the preceding aspects, the final set of SNN model is the updated set of SNN model parameters computed during the second training phase that best improves the performance of the SNN model during the second training phase

According to a further example aspect is a method of training a neural network model using knowledge distillation (KD), comprising: learning an initial set of parameters for a student neural network (SNN) model over a plurality of KD steps, wherein each KD step comprises: updating parameters of the SNN model with an objective of minimizing a difference between SNN model outputs generated by the SNN model for input training data samples and smoothed teacher neural network (TNN) model outputs determined based on TNN model outputs generated by a TNN model for the training data samples, the smoothed TNN model outputs being determined by applying a smoothing function to the TNN model outputs, wherein an impact of the smoothing function on the TNN model outputs is reduced over the plurality of KD steps; and learning a final set of parameters for the SNN model, comprising updating the initial set of parameters learned from the set of KD steps to minimize a difference between SNN model outputs generated by the SNN model in respect of the input training data samples and known training labels of the input training data samples.

### DRAWINGS

FIG. 1 graphically illustrates examples of sharp and smooth loss functions.

FIG. 2 illustrates an example of a KD training system according to example embodiments.

FIG. 3 shows a block diagram of an example simplified processing system which may be used to implement embodiments disclosed herein.

### DESCRIPTION OF THE INVENTION

The present disclosure relates to a method and system for training a neural network model using knowledge distillation which reduces a difference between the accuracy of a teacher neural network model and the accuracy of a student neural network model.

In this regard, a method and system which gradually increases the sharpness of a loss function used for KD training is disclosed, which in at least some applications may guide the training of a student neural network better, particularly when there is a substantial difference between the computational resources available for the teacher neural network model relative to those available for the student neural network model.

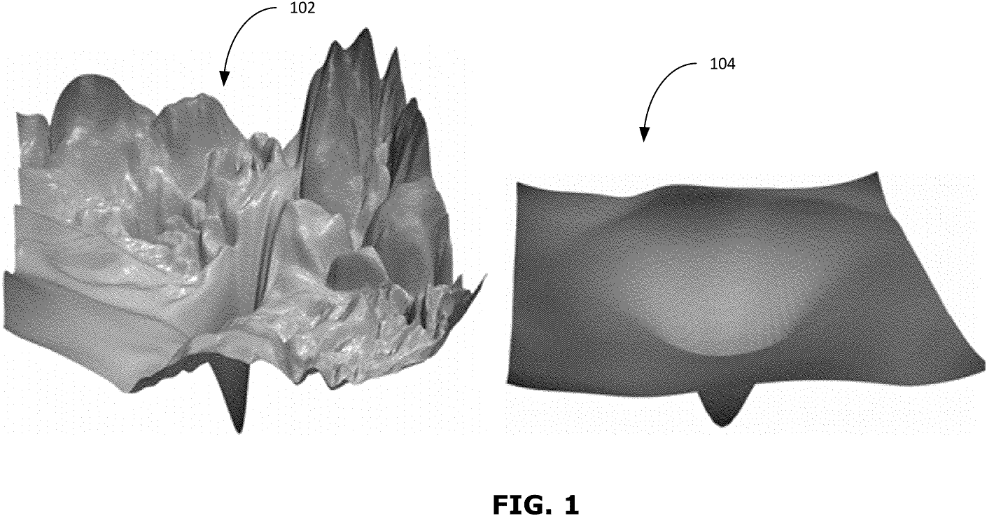

By way of context, FIG. 1 provides a graphical illustration of a “sharp” loss function 102 as compared to a “smooth” loss function 104. In the case of “sharp” loss function 102, a student neural network model may have difficulty converging to an optimal set of parameters that minimize the loss function. Accordingly, example embodiments are directed to dynamically changing the sharpness of the loss function during KD training so that the loss function gradually transitions from a smooth function such as loss function 104 to a sharper loss function 102 during the course of training.

The method and system for training a neural network model using “gradual” knowledge distillation of the present disclosure is configured to, instead of pushing the student neural network model to learn based on a sharp loss function, reduce the sharpness of the loss function at the beginning of training process, and then during the training process increase the sharpness of the target function gradually. In at least some applications, this can enable a smooth transition from a soft function into a coarse function, and training the student neural network model during this transition can transfer the behavior of the teacher neural network model to the student neural network model with more accurate results.

The method and system of the present disclosure may, in at least some example applications, improve knowledge distillation between the teacher neural network model and the student neural network model for both discrete data, such as embedding vectors representative of text, and continuous data, such as image data.

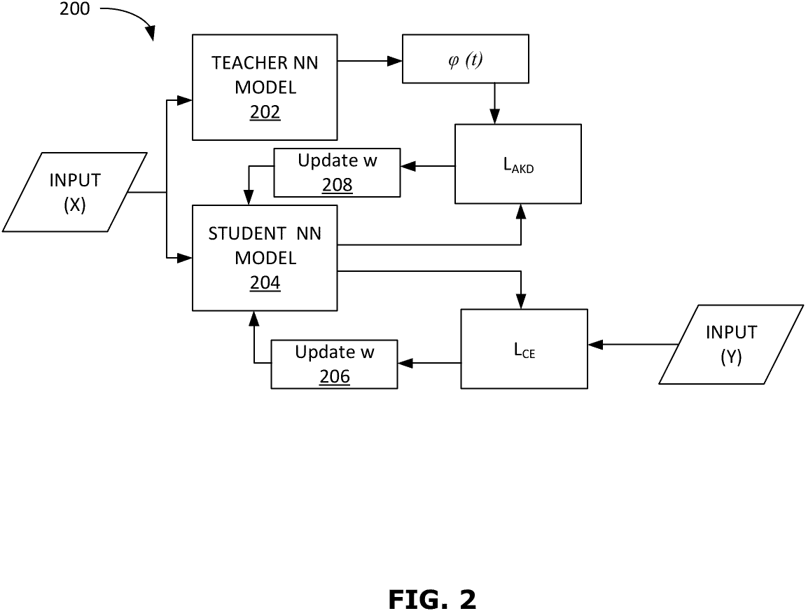

FIG. 2 illustrates a schematic block diagram of a KD training system 200 (hereinafter “system 200”) for training a neural network model using knowledge distillation in accordance with an embodiment of the present disclosure. The system 200 includes a teacher neural network model 202, and a student neural network model 204. The teacher neural network model 202 is a large trained neural network model. The student neural network model 204 is to be trained to approximate the behavior of the teacher neural network model 202. In example embodiments, student neural network model 204 is smaller than the teacher neural network model 202 (i.e., has fewer parameters and/or hidden layers and/or requires fewer computations to implement). A training dataset X,Y of sample pairs

$${\left\{\left({x}_{i} , {y}_{i}\right)\right\}}_{i = 1}^{N}$$

is provided to the system 200 of FIG. 2. The set of Y predefined expected outputs.

The system 200 of FIG. 2 performs a method of the present disclosure that includes two stages or phases. In a first training stage or phase (KD phase), the student neural network model 204 is trained using a first loss function L_{AKD} that has the objective of minimizing a difference between the outputs (e.g., logits generated by a final layer of a neural network model, before a softmax layer of the neural network model) generated by the student neural network model 204 and the teacher neural network model 202 for the input data samples included in input training dataset X. In a second training stage or phase, the student neural network model parameters (e.g., weights w) learned during the KD stage are used as an initial set of parameters for the student neural network model parameters (i.e. student neural network parameters) and are further updated with the objective of minimizing a difference between the outputs (e.g., labels or target one hot vector of classes) generated by the student neural network model 204 and the labels (i.e., set of expected outputs) Y included in the training dataset.

Accordingly, during the first training stage or phase, the system of FIG. 2 trains student neural network model 204 according to a first loss function (KD loss function (ℒ_{AKD}(.), which can be based on mean squared error, KL divergence or other loss functions which can depend on the intended use for the NN) applied to the outputs of student and the teacher network models 204, 202. In example embodiments, prior to computing the KD loss function, the teacher network model 202 output is adjusted by multiplying the logits output by the teacher neural network model 202 with a smoothing factor that is computed using a smoothing function (also referred to as a temperature function) φ(t), as per the following equation:

$${L}_{A K D} \left({w}_{s} , t\right) = L \left({S}_{{w}_{s}} \left(x\right) , T \left(x\right) φ \left(t\right)\right)$$

where smoothing function φ(t) controls the softness of T(x). In the present illustrative example, for simplicity, the ℒ_{AKD}(.) loss function is defined as a mean square error and smoothing function

$$\left(t\right) = \frac{t}{{t}_{max}} ,$$

where tₘₐₓ is a constant, defines the maximum smoothing value (e.g. maximum temperature) for t. Also, t, tₘₐₓ ∈ ℕ, 1 ≤ t ≤ tₘₐₓ . Thus:

$${L}_{A K D} \left({w}_{s} , t\right) = {\left‖{S}_{{w}_{s}} \left(x\right) - T \left(x\right) \frac{t}{{t}_{m a x}}\right‖}^{2}$$

In stage or phase one, the student neural network model 204 is gradually trained with the “smoothed” or “annealing” KD loss function (ℒ_{AKD}(.)) for n epochs where n = k × tₘₐₓ (k e ℕ) and in each of epoch k, the smoothing value (e.g. temperature) t is increased by one unit. The temperature t starts from 1 and in each epoch k it increases one unit until it reaches the value t = tₘₐₓ. Thus, temperature t is uniformly increased over a set of n epochs.

In stage or phase two, the student neural network model 204 is trained with the given data samples and a loss function between the student neural network model 204 and the target labels Y (e.g., known ground truth or true labels y that are provided with the training dataset) of the given data samples for m epochs. Here, in the beginning of the training process the student neural network model’s weights are initialized with the best checkpoint of stage or phase one (e.g., the parameters that were learned in stage or phase one that provided the best performance for minimizing the loss ℒ_{AKD} ). The loss function applied in stage or phase two can be mean square error, cross entropy or other loss functions, depending on the nature of the task that the student neural network model 206 is being trained to perform. Using cross entropy as an illustrative example, the cross entropy loss for phase two can be represented as:

$${L}_{C E} \left({w}_{s}\right) = - \frac{1}{N} {\sum }_{i = 1}^{N} {y}_{i} ⋅ l o g {S}_{{w}_{s}} \left({x}_{i}\right)$$

where N is the number of data samples, yᵢ is the one hot vector of the label of the i′th data sample and xᵢ is the i′th data sample.

Step by Step, the above method can be set out as follows:

Consider the training dataset

$${D}_{t r a i n} = {\left\{\left({x}_{i} , {y}_{i}\right)\right\}}_{i = 1}^{N} ,$$

consisting of N data samples. Also, consider development dataset

$${D}_{d e v} = {\left\{\left({x}_{i} , {y}_{i}\right)\right\}}_{i = 1}^{A}$$

which will be used for evaluating the performance of student neural network after each performance of the steps of phase 1 and the steps of phase 2 to find the best check points. Finally, consider the test dataset

$${D}_{t e s t} = {\left\{\left({x}_{i} , {y}_{i}\right)\right\}}_{i = 1}^{B}$$

which will be used for final evaluation of the student neural network after training. Consider T(x) to be a teacher function (e.g., teacher nueral network model 202) which had been trained on training dataset Dₜᵣₐᵢₙ. The method is as follows:

### 1- Stage or Phase One

a. Step 1) set temperature parameter t = 1.
b. Step 2) For j = 1 to n epochs do:
   i. Train the student neural network model S(.) with ℒ_{AKD}(wₛ,t) loss function
   ii. If j mod k = 0 then:
      1. t = t + 1
   iii. Check the performance of S(.) on D_{dev} dataset.
   iv. If the performance of S(.) on D_{dev} dataset is better than the previous best performance, save S(.) as the best performing student neural network model (i.e., save the parameters (weights w) of S(.).

### 2- Stage or Phase Two

a. Step 1) Load the weights of best student neural network model saved in the previous phase into S(.)
b. Step 2) For j = 1 to m epochs do:
   i. Train the student neural network model S(.) with ℒ_{CE}(wₛ) loss function
   ii. If the performance of S(.) on D_{dev} dataset is better than the previous best performance, save S(.) as the best performing student neural network model (i.e., save the parameters (weights w) of S(.).
c. Step 3) Test the student neural network model S(.) performance on Dₜₑₛₜ dataset.

The methods and systems described above, including each of the teacher neural network mode and the student neural network model can be implemented on one or more computing devices that includes a processing unit (for example a CPU or GPU or special purpose AI processing unit) and persistent storage storing suitable instructions of the methods and systems described herein that can be executed by the processing unit to configure the computing device to perform the functions described above.

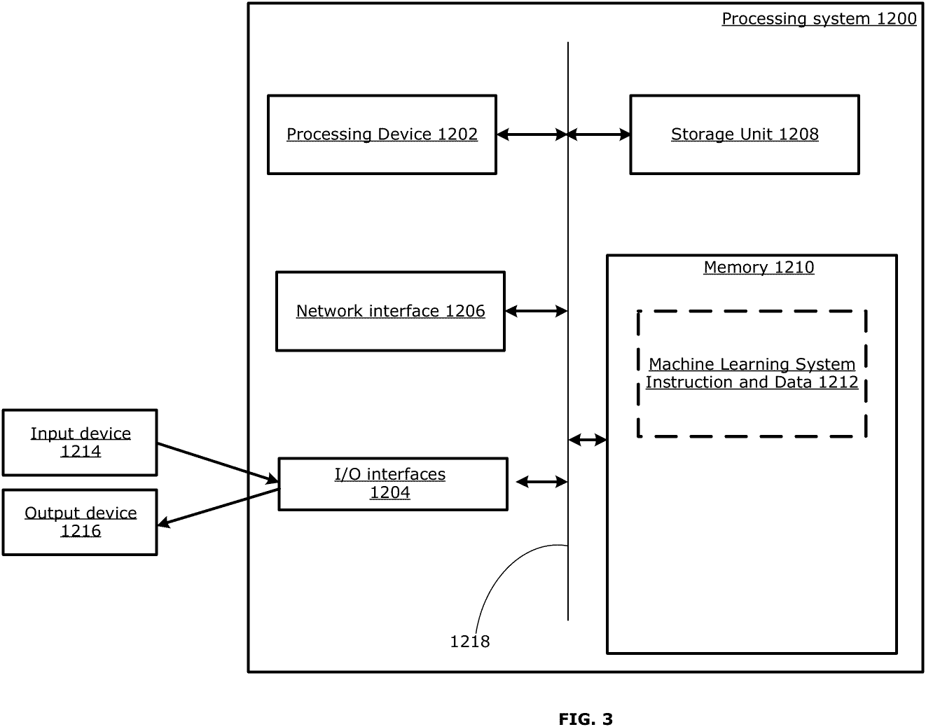

Referring to FIG. 3, a block diagram of an example simplified processing system 1200, which may be used to implement embodiments disclosed herein, and provides a higher level implementation example. One or more of teacher neural network model 202 and the student neural network model 204 well as other functions included in the systems 100 may be implemented in the example processing system 1200, or variations of the processing system 1200,. The processing system 1200 could be a terminal, for example, a desktop terminal, a tablet computer, a notebook computer, AR/VR, or an in-vehicle terminal, or may be a server, a cloud end, a smart phone or any suitable processing system. Other processing systems suitable for implementing embodiments of the methods and systems described in the present disclosure may be used, which may include components different from those discussed below. Although FIG. 3 shows a single instance of each component, there may be multiple instances of each component in the processing system 1200.

The processing system 1200 may include one or more processing devices 1202, such as a graphics processing unit, a processor, a microprocessor, an application-specific integrated circuit (ASIC), a field-programmable gate array (FPGA), a dedicated logic circuitry, accelerator, a tensor processing unit (TPU), a neural processing unit (NPU), or combinations thereof. The processing system 1200 may also include one or more input/output (I/O) interfaces 1204, which may enable interfacing with one or more appropriate input devices 1214 and/or output devices 1216. The processing system 1200 may include one or more network interfaces 1206 for wired or wireless communication with a network.

The processing system 1200 may also include one or more storage units 1208, which may include a mass storage unit such as a solid state drive, a hard disk drive, a magnetic disk drive and/or an optical disk drive. The processing system 1200 may include one or more memories 1210, which may include volatile or non-volatile memory (e.g., a flash memory, a random access memory (RAM), and/or a read-only memory (ROM)). The non-transitory memory of memory 1210 may store instructions for execution by the processing device(s) 1202, such as to carry out examples described in the present disclosure, for example, instructions and data 1212 for system 100. The memory(ies) 1210 may include other software instructions, such as for implementing an operating system for the processing system 1200 and other applications/functions. In some examples, one or more data sets and/or modules may be provided by an external memory (e.g., an external drive in wired or wireless communication with the processing system 1200) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage.

The processing system 1200 may also include a bus 1218 providing communication among components of the processing system 1200, including the processing device(s) 1202, I/O interface(s) 1204, network interface(s) 1206, storage unit(s) 1208 and/or memory(ies) 1210. The bus 1218 may be any suitable bus architecture including, for example, a memory bus, a peripheral bus or a video bus.

The computations of the teacher neural network model 202 and student neural network model 204 may be performed by any suitable processing device 1202 of the processing system 1200 or variant thereof. Further, teacher neural network model 202 and student neural network model 204 may be use suitable neural network model, including variations such as recurrent neural network models, long short-term memory (LSTM) neural network models.

The present disclosure has been made with reference to the accompanying drawings, in which embodiments of technical solutions are shown. However, many different embodiments may be used, and thus the description should not be construed as limited to the embodiments set forth herein. Rather, these embodiments are provided so that this application will be thorough and complete. Wherever possible, the same reference numbers are used in the drawings and the following description to refer to the same elements, and prime notation is used to indicate similar elements, operations or steps in alternative embodiments. Separate boxes or illustrated separation of functional elements of illustrated systems and devices does not necessarily require physical separation of such functions, as communication between such elements may occur by way of messaging, function calls, shared memory space, and so on, without any such physical separation. As such, functions need not be implemented in physically or logically separated platforms, although they are illustrated separately for ease of explanation herein. Different devices may have different designs, such that although some devices implement some functions in fixed function hardware, other devices may implement such functions in a programmable processor with code obtained from a machine-readable storage medium. Lastly, elements referred to in the singular may be plural and vice versa, except where indicated otherwise either explicitly or inherently by context.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e. DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media. Although the present disclosure may describe methods and processes with steps in a certain order, one or more steps of the methods and processes may be omitted or altered as appropriate. One or more steps may take place in an order other than that in which they are described, as appropriate.

Although the present disclosure may be described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable storage medium.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A method of training a student neural network (SNN) model that is configured by a set of SNN model parameters to generate outputs in respect of input data samples, comprising:
obtaining respective teacher neural network (TNN) model outputs for a plurality of input data samples;
performing a first training phase of the SNN model, the first training phase comprising training the SNN model over a plurality of first training phase epochs, each first training phase epoch comprising:
computing SNN model outputs for the plurality of input data samples;
applying a smoothing factor to the teacher neural network (TNN) model outputs to generate smoothed TNN model outputs;
computing a first loss based on the SNN model outputs and the smoothed TNN model outputs; and
computing an updated set of the SNN model parameters with an objective of reducing the first loss in a following first training phase epoch,
wherein the soothing factor is adjusted over the plurality of first training phase epochs to reduce a smoothing effect on the generated smoothed TNN model outputs;
performing a second training phase of the SNN model, the second training phase comprising initializing the SNN model with a set of SNN model parameters selected from the updated sets of SNN model parameters computed during the first training phase, the second training phase of the SNN model being performed over a plurality of second training phase epochs, each second training phase epoch comprising:
computing SNN model outputs for the plurality of input data samples from the SNN model;
computing a second loss based on the SNN model outputs and a set of predefined expected outputs for the plurality of input data samples; and
computing an updated set of the SNN model parameters with an objective of reducing the second loss in a following second training phase,
selecting a final set of SNN model parameters from the updated sets of SNN model parameters computed during the second training phase.

2. The method of claim 1 wherein in each epoch of the first training phase the smoothing factor is computed as smoothing factor
$$= \frac{t}{{t}_{m a x}} ,$$
where tₘₐₓ is a constant and a value of t is incremented in each subsequent first training phase epoch.

3. The method of claim 1 wherein the first loss corresponds to a divergence between the SNN model outputs and the smoothed TNN model outputs.

4. The method of claim 3 wherein the first loss corresponds to a Kullback-Leibler divergence between the SNN model outputs and the smoothed TNN model outputs.

5. The method of claim 1 wherein the second loss corresponds to a divergence between the SNN model outputs and the set of predefined expected outputs.

6. The method of claim 5 wherein the second loss is computed based on a cross entropy loss function.

7. The method of claim 1 further comprising, for each first training phase epoch, determining if the computed updated set of the SNN model parameters improves a performance of the SNN model relative to updated sets of SNN model parameters previously computed during the first training phase in respect of a development dataset that includes a set of development data samples and respective expected outputs, and when the computed updated set of the SNN model parameters does improve the performance, update the SNN model parameters to the computed updated set of the SNN model parameters prior to a next first training phase epoch.

8. The method of claim 7 wherein the set of SNN model parameters used to initialize the SNN model for the second training phase is the updated set of SNN model parameters computed during the first training phase that best improves the performance of the SNN model during the first training phase.

9. The method of claim 7 further comprising, for each second training phase epoch, determining if the computed updated set of the SNN model parameters improves a performance of the SNN model relative to updated sets of SNN model parameters previously computed during the second training phase in respect of the development dataset, and when the computed updated set of the SNN model parameters does improve the performance, update the SNN model parameters to the computed updated set of the SNN model parameters prior to a next epoch.

10. The method of claim 9 wherein the final set of SNN model is the updated set of SNN model parameters computed during the second training phase that best improves the performance of the SNN model during the second training phase.

11. A system for training a student neural network model, comprising one or more processors and a non-transitory storage medium storing software instructions that, when executed by the one or more processors, configure the system to perform a method comprising:
obtaining respective teacher neural network (TNN) model outputs for a plurality of input data samples;
performing a first training phase of the SNN model, the first training phase comprising training the SNN model over a plurality of first training phase epochs, each first training phase epoch comprising:
computing SNN model outputs for the plurality of input data samples;
applying a smoothing factor to the teacher neural network (TNN) model outputs to generate smoothed TNN model outputs;
computing a first loss based on the SNN model outputs and the smoothed TNN model outputs; and
computing an updated set of the SNN model parameters with an objective of reducing the first loss in a following first training phase epoch,
wherein the soothing factor is adjusted over the plurality of first training phase epochs to reduce a smoothing effect on the generated smoothed TNN model outputs;
performing a second training phase of the SNN model, the second training phase comprising initializing the SNN model with a set of SNN model parameters selected from the updated sets of SNN model parameters computed during the first training phase, the second training phase of the SNN model being performed over a plurality of second training phase epochs, each second training phase epoch comprising:
computing SNN model outputs for the plurality of input data samples from the SNN model;
computing a second loss based on the SNN model outputs and a set of predefined expected outputs for the plurality of input data samples; and.

12. Computing an updated set of the SNN model parameters with an objective of reducing the second loss in a following second training phase, selecting a final set of SNN model parameters from the updated sets of SNN model parameters computed during the second training phase.The system of claim 11 wherein in each epoch of the first training phase the smoothing factor is computed as smoothing factor
$$= \frac{t}{{t}_{m a x}} ,$$
where tₘₐₓ is a constant and a value of t is incremented in each subsequent first training phase epoch.

13. The system of claim 11 wherein the first loss corresponds to a divergence between the SNN model outputs and the smoothed TNN model outputs.

14. The system of claim 13 wherein the first loss corresponds to a Kullback-Leibler divergence between the SNN model outputs and the smoothed TNN model outputs.

15. The system of claim 11 wherein the second loss corresponds to a divergence between the SNN model outputs and the set of predefined expected outputs.

16. The system of claim 15 wherein the second loss is computed based on a cross entropy loss function.

17. The system of claim 11 further comprising, for each first training phase epoch, determining if the computed updated set of the SNN model parameters improves a performance of the SNN model relative to updated sets of SNN model parameters previously computed during the first training phase in respect of a development dataset that includes a set of development data samples and respective expected outputs, and when the computed updated set of the SNN model parameters does improve the performance, update the SNN model parameters to the computed updated set of the SNN model parameters prior to a next first training phase epoch.

18. The system of claim 17 wherein the set of SNN model parameters used to initialize the SNN model for the second training phase is the updated set of SNN model parameters computed during the first training phase that best improves the performance of the SNN model during the first training phase.

19. The system of claim 17 further comprising, for each second training phase epoch, determining if the computed updated set of the SNN model parameters improves a performance of the SNN model relative to updated sets of SNN model parameters previously computed during the second training phase in respect of the development dataset, and when the computed updated set of the SNN model parameters does improve the performance, update the SNN model parameters to the computed updated set of the SNN model parameters prior to a next epoch, and wherein the final set of SNN model is the updated set of SNN model parameters computed during the second training phase that best improves the performance of the SNN model during the second training phase.

20. A non-transitory computer readable medium storing software instructions that, when executed by the one or more processors, configure the one or more processors to perform a method comprising:
obtaining respective teacher neural network (TNN) model outputs for a plurality of input data samples;
performing a first training phase of the SNN model, the first training phase comprising training the SNN model over a plurality of first training phase epochs, each first training phase epoch comprising:
computing SNN model outputs for the plurality of input data samples;
applying a smoothing factor to the teacher neural network (TNN) model outputs to generate smoothed TNN model outputs;
computing a first loss based on the SNN model outputs and the smoothed TNN model outputs; and
computing an updated set of the SNN model parameters with an objective of reducing the first loss in a following first training phase epoch,
wherein the soothing factor is adjusted over the plurality of first training phase epochs to reduce a smoothing effect on the generated smoothed TNN model outputs;
performing a second training phase of the SNN model, the second training phase comprising initializing the SNN model with a set of SNN model parameters selected from the updated sets of SNN model parameters computed during the first training phase, the second training phase of the SNN model being performed over a plurality of second training phase epochs, each second training phase epoch comprising:
computing SNN model outputs for the plurality of input data samples from the SNN model;
computing a second loss based on the SNN model outputs and a set of predefined expected outputs for the plurality of input data samples; and
computing an updated set of the SNN model parameters with an objective of reducing the second loss in a following second training phase, selecting a final set of SNN model parameters from the updated sets of SNN model parameters computed during the second training phase.
